(19) United States
(12) Patent Application Publication
(10) Pub. No.: US 2015/0293889 A1
(43) Pub. Date: Oct. 15, 2015

(54) PERCEPTION OF PAGE DOWNLOAD TIME BY OPTIMIZED RESOURCE SCHEDULING

(71) Applicant: Google Inc., Mountain View, CA (US)

(72) Inventors: Simon HATCH, San Francisco, CA (US); Oystein EFTEVAAG, Palo Alto, CA (US); Anthony Charles GENTILCORE, San Francisco, CA (US)

(73) Assignee: Google Inc., Mountain View, CA (US)

(21) Appl. No.: 14/249,326

(22) Filed: Apr. 9, 2014

(51) Int. Cl. G06F 17/22

(52) U.S. Cl. CPC G06F 17/2247

(57) ABSTRACT

Presenting web elements within an application includes receiving layout data associated with a plurality of web elements for presenting within an application. Visibility data associated with each of the plurality of web elements is received. A priority for each web element from the plurality of web elements is defined based on the received layout data and the received visibility data. A subset of the web elements from the plurality of web elements is selected based on the defined priority. The subset of web elements is presented for display within the application.

### BACKGROUND

The present disclosure generally relates to web applications, and in particular, to processing page download events and resource optimization within a web application.

Web applications (e.g., browsers) are used for retrieving, presenting and traversing information resources on the World Wide Web. Page download time is an important part of the user experience when trying to access a website.

### SUMMARY

The disclosed subject matter relates to a system for presenting web elements within an application. The system comprises one or more processors, and a machine-readable medium comprising instructions stored therein, which when executed by the processors, cause the processors to perform operations comprising receiving layout data associated with a plurality of web elements for presenting within an application. The operations further comprise receiving visibility data associated with each of the plurality of web elements. The operations also comprise defining a priority for each web element from the plurality of web elements based on the received layout data and the received visibility data. The operations further comprise selecting a subset of the web elements from the plurality of web elements based on the defined priority. In addition, the operations comprise presenting the subset of web elements for display within the application.

The disclosed subject matter further relates to a machine-readable medium comprising instructions stored therein, which when executed by a system, cause the system to perform operations comprising receiving layout data associated with a plurality of web elements for presenting within an application. The operations further comprise receiving visibility data associated with each of the plurality of web elements. The operations also comprise defining a priority for each web element from the plurality of web elements based on the received layout data and the received visibility data. The operations further comprise presenting one or more of the plurality of web elements for display within the application, based on the defined priority.

The disclosed subject matter also relates to a method for presenting web elements within an application. The method comprises receiving layout data associated with a plurality of web elements for presenting within an application. The method further comprises receiving visibility data associated with each of the plurality of web elements. The method also comprises defining a priority for each web element from the plurality of web elements based on the received layout data and the received visibility data. The method further comprises selecting a subset of the web elements from the plurality of web elements based on the defined priority. In addition, the method comprises presenting the subset of web elements for display within the application, wherein the visibility data associated with each of the plurality of web elements corresponds to a location where each web element is displayed within the application.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment in which resource optimization during a page download event is processed within a web application, according to an embodiment.

FIG. 2 is a schematic illustration of a resource optimization platform, according to an embodiment.

FIG. 3 is a flowchart of a process for providing research optimization, according to an embodiment.

FIG. 4 is a block diagram illustrating an example of resource optimization during a page download event associated with a web application.

FIG. 5 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, web applications are used for retrieving, presenting and traversing information resources on the World Wide Web. Page download time is an important part of the user experience when trying to access a website. However, user perception of page download time can also be important. Therefore, it may be desirable to improve the perceived speed of an application instead of or in addition to the actual speed of the application.

The subject disclosure provides for optimization of scheduling of image resources, such that a downloaded page appears to be visually complete faster than it is actually downloaded. Typically, images are scheduled to be downloaded in the same order they are discovered in a resource library, but the images that are being presented to a user first (e.g., in a current viewport) may not be scheduled first. By the time those images are discovered in the library, the network may be busy handling resources outside of a viewport (e.g., a visible part of the display), and the user's experience is degraded as a result. The subject disclosure provides improved perceived page download performance by utilizing the incomplete visibility information taken during a layout to speculatively re-order the queued images.

While working with web applications (e.g., browsers), user perception of page download time can be as important as, or even more important than, the actual page download time. An important aspect of optimizing application speed is improving the perceived speed such that the user is presented with some content while a complete content is downloaded.

For example, a user of a computing device may use an application A to navigate to a page which can be completely downloaded and displayed in 10 seconds. However, an application B may take 12 seconds to completely download the page but can present some representation of the page that may seem visually complete and interact-able by the 5 second mark.

In the above two user experiences, perception of the user is that application B is faster than application A, although in fact application B takes longer than application A to completely download the page. Any small amount of time saved before the user perceives the page to be visually complete can result in a drastic improvement in overall user experience. For applications with hundreds of millions of users, this translates into significant time saved per day.

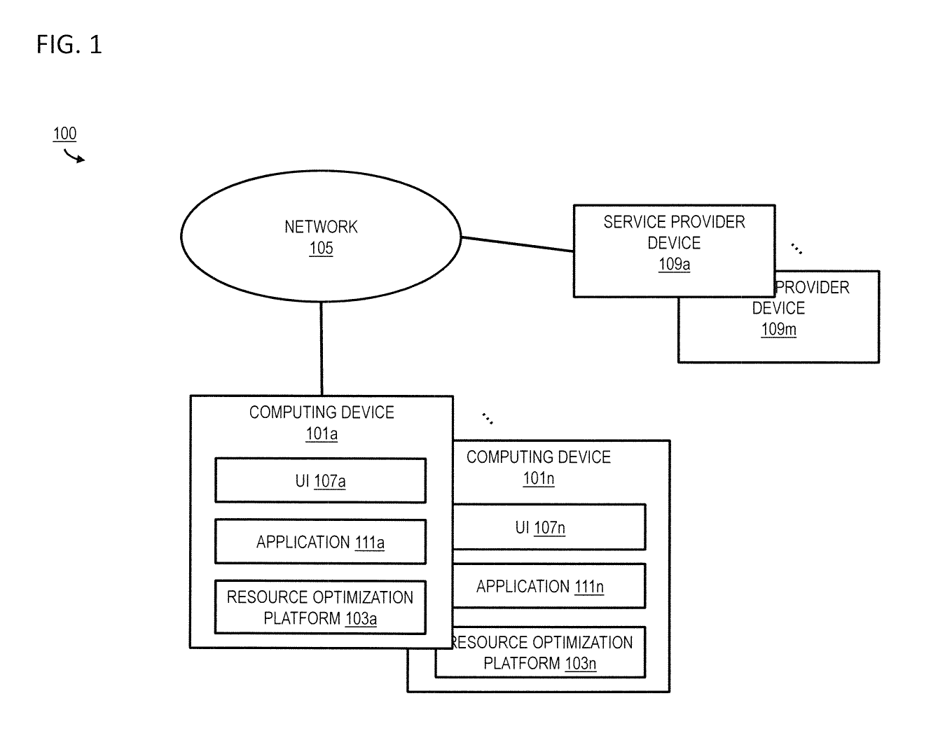

FIG. 1 illustrates an example network environment in which resource optimization during a page download event is processed within a web application, according to an embodiment. A network environment 100 includes computing devices 101a-101n and service provider devices 109a-109m. Computing devices 101a-101n and service provider devices 109a-109m can communicate with each other through a network 105. A service provider device 109a-109m can include one or more computing devices and one or more computer-readable storage devices (not shown).

Each of computing devices 101a-101n can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 101a-101n and service provider devices 109a-109m may be provided access to or receive application software executed or stored on any of the other computing devices 101a-101n or service provider devices 109a-109m.

The service provider devices 109a-109m may be any system or device having a processor, a memory, and communications capability for providing content to the computing devices 101a-101n. In some example aspects, a service provider device 109a-109m can be a single computing device, for example, a computer server. In other embodiments, a service provider device 109a-109m can represent more than one computing device working together to perform the actions of a server computer (e.g., cloud computing). Further, a service provider device 109a-109m can represent various forms of servers including, but not limited to a web server, an application server, a proxy server, a network server, or a server farm.

In some aspects, the computing devices 101a-101n may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 105. Network 105 can be a large computer network, for example, a local area network (LAN), wide area network (WAN), the Internet, a cellular network, or a combination thereof connecting any number of mobile clients, fixed clients, and servers. Further, the network 105 can include, but is not limited to, any one or more of the following network topologies, including a bus network, a star network, a ring network, a mesh network, a star-bus network, tree or hierarchical network, and the like. In some aspects, communication between each client (e.g., computing devices 101a-101n) and a service provider device 109a-109m can occur via a virtual private network (VPN), Secure Shell (SSH) tunnel, or other secure network connection. In some aspects, network 105 may further include a corporate network (e.g., intranet) and one or more wireless access points.

In example aspects, a user at any of computing devices 101a-101n can provide user input within an application 111a-111n (e.g., a web browser) on the computing device. The user input can specify which web content to download. For example, a user input can be a Uniform Resource Locator (URL) address associated with a website specifying what web content to be downloaded from a service provider device 109a-109m. The user may also enter input to specify what part of a website the user wishes to see on a User Interface (UI) 107a-017n of the computing device 101a-101n. In such example aspects, each of computing devices 101a-101n can include a resource optimization platform 103a-103n, which can select, based on user input, a visible subset of the downloaded content to present to the user via the UI 107a-107n.

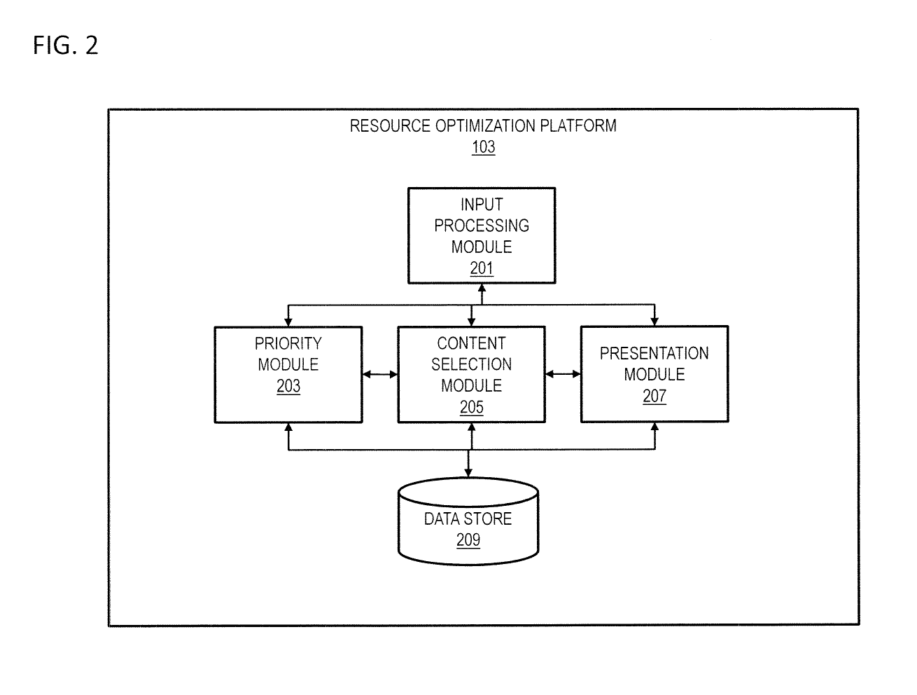

FIG. 2 is a schematic illustration of a resource optimization platform, according to an embodiment. Resource optimization platform 103 can be similar to the resource optimization platform 103a-103n of FIG. 1. As shown in FIG. 2, a resource optimization platform 103 can include an input processing module 210, a priority module 203, a content selection module 205, a presentation module 207, and a data store 209.

As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

The resource optimization platform 103 can provide improved perception of page download on a computing device 101a-101n. In some instances, the input processing module 201 can receive layout data associated with a set of web elements. The input processing module 201 can also receive visibility data associated with each of the plurality of web elements. The visibility data may be received from the application 111a-111n. The application 111a-111n can, for example, be a Web browser. However, the subject technology can apply to other applications (e.g., native applications on a mobile device) for accessing web content or resources (e.g., websites). In some instances, the priority module 203 defines a priority for each web element from the plurality of web elements based on the received layout data and the received visibility data. In some instances, the content selection module 205 can select a subset of the web elements from the plurality of web elements based on the defined priority. In some instances, the presentation module 207 can present the selected subset of web elements for display within the application. For example, the presentation module 207 can send the subset of web elements to application 111a-111n.

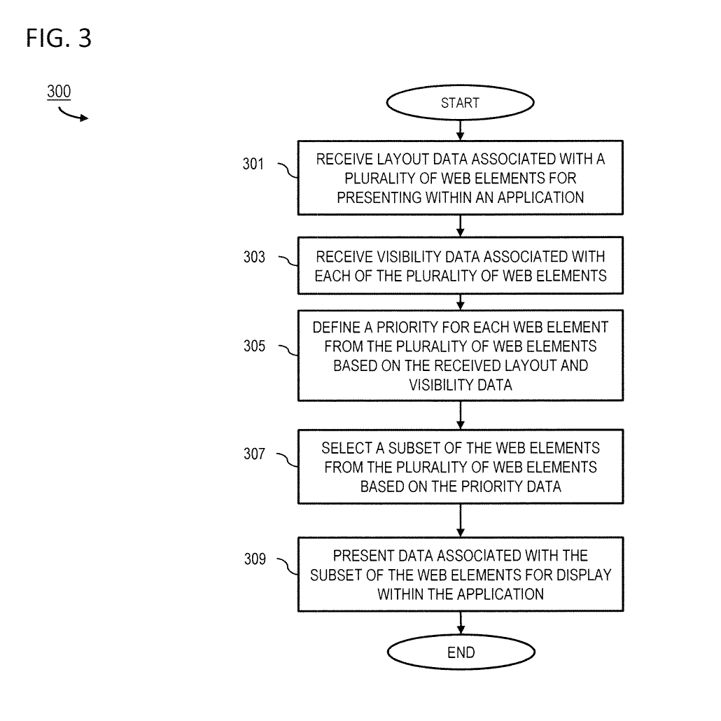

FIG. 3 is a flowchart of a process for providing research optimization, according to an embodiment. Although FIG. 3 is described with reference to FIGS. 1 and 2, the subject technology is not limited to such and can apply to other computing devices and systems. At block 301, the input processing module 201 can receive layout data associated with a set of web elements (e.g., images, text or other web content) for presenting within an application. The layout data can associate a location with each element from the set of web elements. The layout data can, for example, be provided by the service provider device 109a-109m within a HyperText Markup Language (HTML) file. The HTML file can be downloaded by the application 111a-111n from the service provider device 109a-109m via the network 105 and stored at a local storage on the computing device 101a-101n (not shown in FIG. 1). The application 111a-111n of FIG. 1 can process the HTML file and obtain the layout data from the HTML file. The application 111a-111n can then send the obtained layout data to the resource optimization platform 103a-103n. In other instances, the resource optimization platform 103a-103n can directly access the HTML file on the computing device 101a-101n and obtain the layout data. The input processing module 201 can receive the layout data and store the layout data in data store 209.

At block 303, the resource optimization platform 103 can receive visibility data associated with each of the plurality of web elements. The visibility data may be received from the application 111a-111n. The visibility data can indicate a subset of the web elements from the layout data that can be visible on a UI 107a-107n of the computing device 101a-101n based on a viewing region of the layout. The input processing module 201 can receive the visibility data from application 111a-111n and store the visibility data in data store 209.

At block 305, the priority module 203 defines a priority for each web element from the plurality of web elements based on the received layout data and the received visibility data. For example, the priority module 203 can define the priority for a web element based on a distance between the location associated with that web element in the layout and a viewing region of the layout on the UI 107a-107n. The priority module 203 may store the priorities defined for the plurality of web elements in data store 209.

At block 307, the content selection module 205 can select a subset of the web elements from the plurality of web elements based on the defined priority. For example, a web element may be selected by the content selection module 205, if the distance between the web element and the viewing region of the UI 107a-107n is smaller than a predefined threshold. The remaining web elements with distances from the viewing region higher than the predefined threshold may not be selected. The selected subset of web elements can be stored in data store 209.

At block 309, the presentation module 207 can present the selected subset of web elements for display within the application. For example, the presentation module 207 can send the subset of web elements to application 111a-111n. The application 111a-111n can then display content associated with the subset on the UI 107a-107n of the computing device 101a-101n. In some instances, the application 111a-111n may download the subset of web elements based on a predefined download schedule, prior to presenting the subset on the UI 107a-107n.

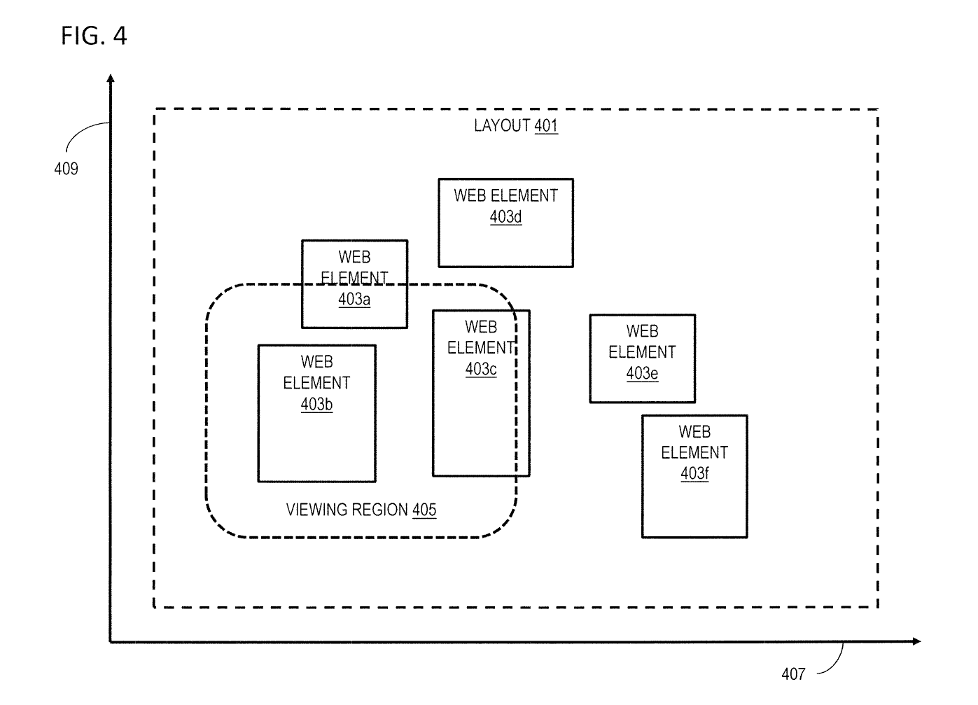

FIG. 4 is a block diagram illustrating an example of resource optimization during a page download event associated with a web application. Although FIG. 4 is described with reference to FIGS. 1 and 2, the subject technology is not limited to such and can apply to other computing devices and systems. In some instances, the resource optimization platform 103 of FIG. 2 optimizes the scheduling of web elements (e.g., image resources) such that a page displayed on a UI 107a-107n of a computing device 101a-101n appears to be visually complete faster. In conventional systems, images may be scheduled to be downloaded in the same order they are discovered in an HTML file. For example, a layout 104 as defined in a HTML file may include web elements 403a-403f. Each web element 403a-403f can have a location with regards to the layout 401. For example, a location of a web element 403a-403f can be defined by coordinates associated with each web element with regards to a two dimensional area represented by axes 407 and 409. However, an order in which the web elements 403a-403f appear in an HTML file associated with layout 401 may not be the same order as the web elements appear in a viewing region (e.g., a viewport) 405. For example, by the time an application 111a-111n finds a web element 403b in the HTML file associated with layout 401, the network 105 may be downloading resources (e.g., web elements) outside of the viewing region 405 such as, for example, a web element 403f. In such instances, a user of the computing device 101a-101n may experience a delay in downloading the web element 403b.

In some instances, the resource optimization platform 103 utilizes the incomplete visibility information taken during layout to speculatively re-order the queued web elements, for example, by downloading web element 403b before web element 403f, even though their initial download order may be different. The priority module 203 can implement priority of each web element 403a-403f as a score for the web element, where the score is adjusted based on factors such as, for example, a distance between the web element and the viewing region 405, a display space available within the viewing region 405, a dimension of the web element, etc. Subsequently, when selecting a subset of the web elements 403a-403f (as seen in block 307 of FIG. 3) the content selection module 205 can compare the priority scores for web elements 403a-403f and select web elements with highest scores to be presented within an application 111a-111n. For example, the web elements meeting a predefined threshold may be displayed. Alternatively, or in addition, the web elements can be ranked based on their scores, and the web elements are displayed based on their ranking (e.g., with an initial display of a predetermined number of web elements).

The priority module 203 may initially associate a default priority to all of the web elements 403a-403f and upgrade the priority on any web element that might potentially be visible, once layout data becomes available. This can be further refined by prioritizing based on a distance between the web element and the viewing region 405. For example, among the web elements 403a-403f, the web element 403a may be associated with the lowest distance from the viewing region 405 while the web element 403f may have the highest distance from the viewing region 405. Furthermore, the priority module 203 may prioritize the web elements 403a-403f based on estimated amount of display space associated with the web element, a dimension associated with the web element, or a format associated with the web element.

In some instances, the layout 401 is updated multiple times by the application 111a-111n until the download is completed. In such instances, the resource optimization platform 103 can perform operations as described with regards to FIG. 3 for each layout 401 and download the web elements based on the layout and visibility associated with each layout. For example, the layout data 401 can correspond to a Document Object Model (DOM) tree generated based on the HyperText Markup Language (HTML). In such example, with each layout update the DOM tree is modified until the download is completed. The layout 401 may be updated when a user scrolls up or down and the viewing region 405 is updated, or a new layout is provided by the application 111a-111n.

In some instances, the resource optimization platform 103 may use various techniques to determine the distance between a web element 403a-403f and the viewing region 405. For example, the resource optimization platform 103 may use a point test to determine whether a location associated with a web element 403a-403f is inside the limits of the viewing region 405, or outside the limits of the viewing region 405 with a distance from the limits. The point test can be, for example, implemented using a cross product function by checking whether one or more points associated with a location corresponding to the web element 403a-403f are lying on the same side of all elements (e.g., sides) of the viewing region 405, or on different sides of the elements.

In some instances, the resource optimization platform 103 may use probabilistic analysis for determining web element priorities. For example, the priority module may store data history associated with resource optimization for multiple layouts in data store 209, analyze the data and determine priorities based on analysis results.

In some instances, the resource optimization platform 103 can store the downloaded subset of the web elements 403a-403f in data store 209. The resource optimization platform 103 may receive a request for displaying one or more of the web elements 403a-403f within the application. For example, the resource optimization platform 103 may receive the request from the application 111a-111n. Upon receiving the request, the content selection module 205 can determine whether the elapsed time between the storing the downloaded subset and the receiving the request is within a predetermined period of time. If the elapsed time is within the predetermined period, the presentation module 207 can present the stored subset to the application 111a-111n to be displayed on a UI 107a-107n. However, if the elapsed time is not within the predetermined period (e.g., a long time elapsed since the downloaded subset was saved) the priority module 203 may define an updated priority for each web element 403a-403f and the content selection module 205 selects a new subset of the web elements based on the defined priority, as discussed above with respect to FIG. 3. In this manner, it is possible to reuse the saved downloaded subset for a time period after the subset is downloaded without the need to repeat the download process. This can reduce download time and increase the speed of presentation of data associated with the subset of web elements for display in viewing region 405 within application 111a-111n.

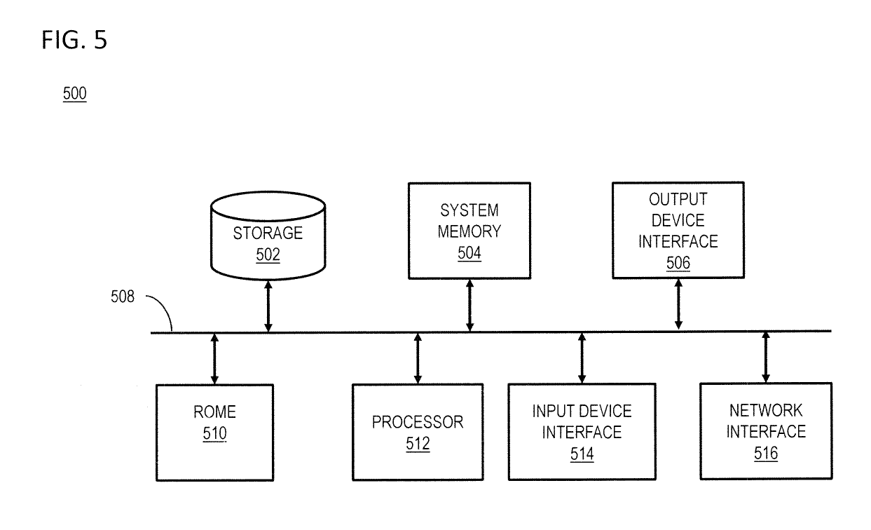

FIG. 5 conceptually illustrates an example electronic system with which some implementations of the subject technology can be implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (for example, a magnetic or optical disk and its corresponding disk drive) as permanent storage device 502.

Other implementations use a removable storage device (for example, a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, or ROM 510. For example, the various memory units include instructions for presenting web elements in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, for example, cathode ray tubes (CRT) or liquid crystal displays (LCD). Some implementations include devices, for example, a touchscreen that functions as both input and output devices.

Finally, as shown in FIG. 5, bus 508 also couples electronic system 500 to a network (not shown) through a network interface 516. In this manner, the computer can be a part of a network of computers (for example, a local area network (“LAN”), a wide area network (“WAN”), or an Intranet, or a network of networks, for example, the Internet. Any or all components of electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a Web browser on a user's client device in response to requests received from the Web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A system for presenting web elements within an application, the system comprising:
one or more processors; and
a machine-readable medium comprising instructions stored therein, which when executed by the processors, cause the processors to perform operations comprising:
receiving layout data associated with a plurality of web elements for presenting within an application;
receiving visibility data associated with each of the plurality of web elements;
defining a priority for each web element from the plurality of web elements based on the received layout data and the received visibility data;
selecting a subset of the web elements from the plurality of web elements based on the defined priority; and
presenting the subset of web elements for display within the application.

2. The system of claim 1, wherein the layout data corresponds to a Document Object Model (DOM) tree generated based on HyperText Markup Language (HTML) corresponding to the plurality of web elements.

3. The system of claim 1, wherein the plurality of web elements comprises images.

4. The system of claim 1, wherein the visibility data associated with each of the plurality of web elements corresponds to a location where each web element is displayed within the application.

5. The system of claim 4, wherein for each web element, the visibility data associated with the web element indicates whether the location associated with the web element is within a viewing region of the application.

6. The system of claim 4, wherein for each web element, the priority is based on at least one of a distance between the location associated with the web element and the viewing region of the application, an estimated amount of display space associated with the web element, a dimension associated with the web element, or a format associated with the web element.

7. The system of claim 1, the operations further comprising:
downloading, prior to the presenting, the subset of web elements based on a predefined download schedule.

8. The system of claim 7, the operations further comprising:
storing the downloaded subset of the web elements;
receiving a request for displaying one or more of the plurality of web elements within the application; and
determining that an elapsed time between the storing the downloaded subset and the receiving the request is within a predetermined period of time,
wherein presenting the subset is in response to the determining.

9. The system of claim 1, the operations further comprising:
presenting, after presenting the subset, the remaining web elements of the plurality of web elements for display within the application.

10. A machine-readable medium comprising instructions stored therein, which when executed by a system, cause the system to perform operations comprising:
receiving layout data associated with a plurality of web elements for presenting within an application;
receiving visibility data associated with each of the plurality of web elements;
defining a priority for each web element from the plurality of web elements based on the received layout data and the received visibility data; and
presenting one or more of the plurality of web elements for display within the application, based on the defined priority.

11. The machine-readable medium of claim 10, wherein the layout data corresponds to a Document Object Model (DOM) tree generated based on HyperText Markup Language (HTML) corresponding to the plurality of web elements.

12. The machine-readable medium of claim 10, wherein the plurality of web elements comprises images.

13. The machine-readable medium of claim 10, wherein the visibility data associated with each of the plurality of web elements corresponds to a location where each web element is displayed within the application.

14. The machine-readable medium of claim 13, wherein for each web element, the visibility data associated with the web element indicates whether the location associated with the web element is within a viewing region of the application.

15. The machine-readable medium of claim 13, wherein for each web element, the priority is based on at least one of a distance between the location associated with the web element and the viewing region of the application, an estimated amount of display space associated with the web element, a dimension associated with the web element, or a format associated with the web element.

16. The machine-readable medium of claim 10, the operations further comprising:
downloading, prior to the presenting, the subset of web elements based on a predefined download schedule.

17. The machine-readable medium of claim 16, the operations further comprising:
storing the downloaded subset of the web elements;
receiving a request for displaying one or more of the plurality of web elements within the application; and
determining that an elapsed time between the storing the downloaded subset and the receiving the request is within a predetermined period of time,
wherein presenting the subset is in response to the determining.

18. The machine-readable medium of claim 16, wherein presenting one or more of the plurality of web elements comprises:
selecting a subset of the web elements from the plurality of web elements based on the defined priority; and
presenting the subset of web elements for display within the application.

19. The machine-readable medium of claim 10, the operations further comprising:
presenting, after presenting the subset, the remaining web elements of the plurality of web elements for display within the application.

20. A method for presenting web elements within an application, the method comprising:
receiving layout data associated with a plurality of web elements for presenting within an application;
receiving visibility data associated with each of the plurality of web elements;
defining a priority for each web element from the plurality of web elements based on the received layout data and the received visibility data;
selecting a subset of the web elements from the plurality of web elements based on the defined priority; and
presenting the subset of web elements for display within the application,
wherein the visibility data associated with each of the plurality of web elements corresponds to a location where each web element is displayed within the application.
